(19) United States
(12) Patent Application Publication
(10) Pub. No.: US 2020/0108655 A1
(43) Pub. Date: Apr. 9, 2020

(54) Method for Creating a Three-Dimensional Decorative Sculpture

(71) Applicants: Lilah Jurgens, New Orleans, LA (US); Marcie Matthew, Long Beach, MS (US)

(72) Inventors: Lilah Jurgens, New Orleans, LA (US); Marcie Matthew, Long Beach, MS (US)

(21) Appl. No.: 16/153,281

(22) Filed: Oct. 5, 2018

(51) Int. Cl. B44C 3/06; B44C 1/24; B44C 3/04; B44B 1/00

(52) U.S. Cl. CPC B44C 3/06; B44B 1/006; B44C 3/04; B44C 1/24

(57) ABSTRACT

A method for creating a sculpture is disclosed. Such a method may include importing a two-dimensional image into a computer having a 3D sculpting program, and using said program to create a three-dimensional model of the two-dimensional image. A prototype of the three-dimensional model may then be printed with a 3D printer. The prototype may then be placed into a container and submerged in a casting solution. Once the casting solution cures, forming a mold, the prototype is removed, and a molding material may be poured or inserted into the void resulting from the removal of the prototype. Once the molding material is cured, it may be removed from the mold, forming a three-dimensional sculpture. Such methods may be used for casting such decorative objects as intaglios, reliefs, plaques, cameos, busts, silhouettes, medallions, and coins.

### FIELD OF THE INVENTION

The present invention is generally related to decorative sculptures for the purpose of interior design, and, more particularly, to methods for creating three-dimensional decorative sculptures from contemporary subject matter and media, including from two dimensional images, in the manner of traditional decorative intaglios.

### CROSS-REFERENCES TO RELATED INVENTIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

Generally, an “intaglio” is an engraving or incised figure in stone or other hard material depressed below the surface so that an impression from the design yields an image in relief. But in the field of interior design, the term “intaglio” refers to a miniature portraiture, scene, or sculpture, that is hand-cast from an object, such as an antique. A mold is made from the original object and the object is cast in plaster or other such material. Once cast, intaglios are typically displayed for decorative purposes, such as in decorative boxes, within frames hung on walls, or free standing.

Intaglios have been highly coveted in the interior design market for hundreds of years. For example, in the 18^{th} century, certain businesses took note of the fact that many antiques and ancient works, such as carved gems, cameos, coins, and other such items, were limited to private collections across Europe, making it impossible for the public at large to view and appreciate such objects. Since engravings and other facsimiles offered at best an imperfect idea of the originals, those businesses began offering “perfect impressions” of the antique/ancient objects as a means of making them available to the public at a smaller expense. Since taking an “impression” of the original object provided a perfect copy of the original, the public was able to appreciate the artistry of the original object, rather than an “imperfect” copy created by another artist attempting to duplicate the original by hand through hand-sculpting, hand-carving, etc.

Thus, an intaglio, which is cast from a perfect impression of an original antique, maintains the delicacy of the original work while also possessing the three-dimensional solidity of statutes. However, since each decorative intaglio is cast from a pre-existing object, over the years the market has become stagnant due to a lack of new subject matter. It is therefore desirable to develop a method that would allow the introduction of new subject matter into the creation of traditional decorative intaglios. Such method(s) may also be used for the creation of other such hand-cast objects, such as cameos, plaques, busts, and silhouettes, reliefs, medallions, and coins.

### SUMMARY OF THE INVENTION

Because the subject matter for traditional intaglios created in the field of interior design has been limited to existing objects, the market for this historically-fixed art form has become stagnant due to a lack of new subject matter. It is therefore an object of the present invention to provide a method for creating a sculpture, such as an intaglio, cameo, plaque, relief, bust, silhouette, medallion, or coin that combines the benefits of modern computing and 3D printing technologies with traditional sculpting and casting methods for the production of decorative intaglios such that new subject matter may be introduced to the historically-fixed art form.

According to an exemplary embodiment of the present invention, a method for creating a sculpture may include importing a two-dimensional image into a computer having a 3D digital sculpting program. If the two-dimensional image is of sufficient size, quality, and resolution, it may be mapped onto the surface of a polymesh having a resolution of at least 128 polygons. The polymesh may then be sculpted into a 3D model that is three-dimensional representation of the two-dimensional image. It may be desirable to sculpt certain attributes of the two-dimensional image separately, then combine the separately sculpted attributes into the 3D model. A physical prototype of the 3D model may then be printed with a 3D printer. The prototype may then be used to form a mold by placing the prototype into a suitable container, submerging it in a casting solution, and allowing the solution to cure. Once the solution is cured, the prototype may be removed to form a mold cavity, into which a molding material may be inserted or applied. Once the molding material has cured, it may then be removed to form the finished sculpture, which may be an intaglio, a relief, a bust, a cameo, a plaque, or a silhouette, medallion or coin.

### BRIEF DESCRIPTION OF THE DRAWINGS

FIG. 1 provides isometric illustrations of an original object, a mold, and an intaglio, according to an exemplary embodiment of the present invention.

FIG. 2 is a flowchart of a method for creating an intaglio, according to an exemplary embodiment of the present invention.

FIG. 3 illustrates certain elements of a method for creating a three-dimensional model of a two-dimensional image, according to an exemplary embodiment of the present invention.

FIG. 4 illustrates certain elements of a method for creating a three-dimensional model of a two-dimensional image, according to an exemplary embodiment of the present invention.

### DETAILED DESCRIPTION

Embodiments of the present invention combine the benefits of computing and three-dimensional printing technologies with methods for the hand-casting of traditional intaglios and other sculptures such that new subject matter may be introduced into the art form.

A method for creating a traditional intaglio may begin with the selection of an object that will be the subject of the intaglio. In the field of interior design, it is common to select a pre-existing item, such as a coin, sculpture, cameo, or any other such work of art having a three-dimensional structure at the subject of the intaglio. The object may then be placed into a container suitable for casting in which the mold for the intaglio will be created. As such, the container should have enough volume to receive the entire object such that it is positioned below the container rim, and the inside surface of the container may have a non-stick coating such that the mold can be removed without damage once it has been prepared.

Once the object is inside the container, a casting solution may be prepared. Any solution suitable for the formation of a mold, such as rubber or ceramic, may be used. The solution may then be poured into the container such that the object is completely submerged in the solution within the container. It may be desirable to then tap or otherwise agitate the container such that any air bubbles within the solution are released to avoid compromising the structure of the mold.

The solution should then be allowed to cure in a manner suitable for the casting solution selected. For example, if a two-part silicone solution is used, the solution may be allowed to cure for twenty-four hours at room temperature. Once the casting material is cured, it may be removed from the container such that it forms a mold, and the object may be removed from the material such that the remaining void forms a mold cavity.

Next, a molding material may be selected from which the intaglio is cast. The molding material may be any one of plaster, clay, wax, metal, porcelain, stone, plastic, acrylic, colored acetate, rubber, glass, polyurethane or any other material that is or can be poured into a mold cavity, cured, and removed to form an object. Before casting the intaglio in the mold, it may be desirable to apply a non-stick solution, sometimes referred to in the art as a mold release solution, to the mold cavity such that the intaglio may be easily released from the cavity without damage to either the mold or the intaglio once the mold material is cured. Once the mold cavity has been prepared, the molding material, or a solution thereof, is poured into the cavity and allowed to cure in a manner appropriate for the selected material. Before curing, it may be desirable to tap or otherwise agitate the material in the mold cavity such that any air bubbles contained therein are released. While some materials may cure over time at room temperatures, others may require the application of heat in a kiln, oven, or other such device. Once the molding material has dried or cured completely, the finished intaglio may be removed from the mold.

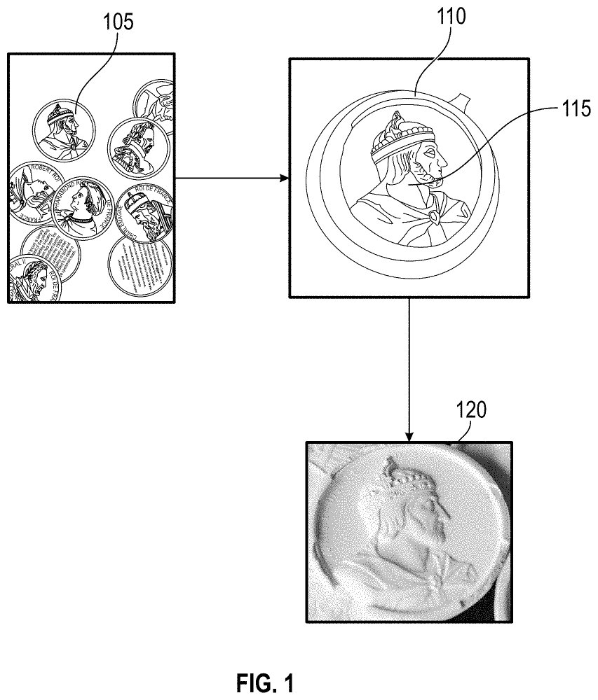

FIG. 1 illustrates an intaglio 120 that may be cast using the aforementioned method. An object 105 may be selected, placed into a container suitable for casting, and submerged in a casting solution, which is then allowed to cure in a manner appropriate for the casting solution used. Once cured, the casting solution may be removed from the container to form mold 110. Object 105 may then be removed from mold 110 to form mold cavity 115. A molding material may then be selected and prepared in a manner appropriate for the selected material, then poured or otherwise applied to mold cavity 115. Once the molding material has been allowed to cure, it may be removed from mold cavity 115 to form intaglio 120. Intaglio 120 may then be freestanding or placed within or affixed to a frame, base, display case, wall, or any other such material or item such that it may be displayed in a decorative manner.

Due to the lack of new subject matter, given that objects selected as the subject of traditional decorative intaglios and other such sculptures are typically pre-existing objects, it is therefore desirable to utilize modern computing and printing technology to introduce new subject matter. Thus, it is an object of the present invention to provide a method for creating a decorative intaglio. According to an exemplary embodiment of the present invention, a two-dimensional object may be selected as the subject of a traditional decorative intaglio.

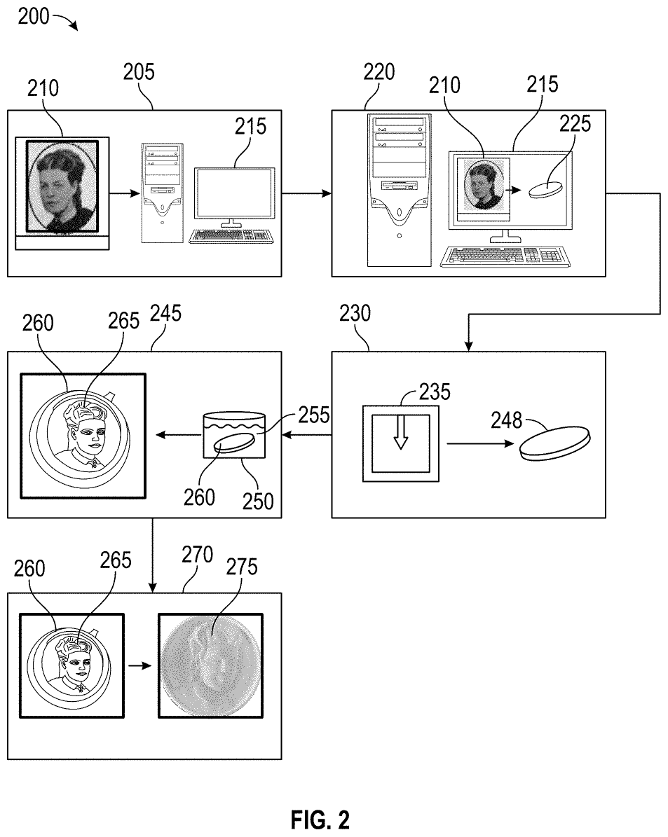

FIG. 2 is a flowchart describing a method 200 for creating a sculpture, such as an intaglio, according to an exemplary embodiment of the present invention. Step 205 may include selecting a two-dimensional image 210 and importing it into computer 215. Two-dimensional image 210 may already be in a digital format, or it may be printed, in which case two-dimensional image 210 may be scanned into a digital image before being imported into computer 215. Computer 215 may have a digital sculpting program. Said digital sculpting program may include any such software package known in the art for creating and sculpting a three-dimensional digital model. Such software packages may include ZBrush, Mudbox, Meshmixer, 3D Coat, Sculptris, Blender, Cinema 4D, MODO, Maya, or any such similar software packages. Computer 215 may be any computer known in the art configured to include and run said digital sculpting program.

Step 220 may include using computer 215 to create three-dimensional model 225 of two-dimensional image 210 with the aforementioned digital sculpting program. In certain embodiments of the present invention, three-dimensional model 225 may comprise a plurality of polygons. Said plurality of polygons may be configured to form a polymesh. In certain embodiments, three-dimensional model 225 may be further configured such that the geometry of the plurality of polygons is evenly distributed across the polymesh.

Before two-dimensional image 210 can be mapped onto three-dimensional model 225, three-dimensional model 225 must be of a sufficient resolution appropriate for two-dimensional image 210. In certain embodiments of the present invention, the resolution of said three-dimensional model 225 will be at least 128 That is, the aforementioned plurality of polygons configured to form the polymesh will contain at least 128 polygons. Once a sufficient resolution has been selected for three-dimensional model 225, two-dimensional image 210 may be mapped onto three-dimensional model 225. In certain embodiments of the present invention, two-dimensional image 210 may be mapped onto three-dimensional model 225 as a texture.

Once two-dimensional image 210 is mapped onto three-dimensional model 225, general digital sculpting techniques known in the art may be used to sculpt three-dimensional model 225 into a three-dimensional representation of two-dimensional image 210. Such techniques may include nudge, pinch, polish, build up, move, transpose, and any other techniques known in the art. For example, if the ZBrush software package is the selected digital sculpting program, the aforementioned techniques (or “Brushes” as referenced in that particular software package) may include Transpose, Move, DamStandard, ClayBuildUp, TrimDynamic, Nudge, Pinch, MaskPen, and Polish. Keeping in mind that three-dimensional model 225 will ultimately become a mold for the completed decorative sculpture, the three-dimensional attributes of three-dimensional model 225 should be of sufficient height and depth such that the original subject of two-dimensional image 210 is satisfactorily rendered in the finished product.

In certain embodiments of the present invention, such as when two-dimensional image 210 is unavailable or undesired, step 205 may be eliminated. In such embodiments, step 220 may include using computer 215 and the aforementioned digital sculpting program to create three-dimensional model 225 as an original work. In these embodiments of the present invention, three-dimensional model 225 may also comprise a plurality of polygons. Said plurality of polygons may be configured to form a polymesh. In certain embodiments, three-dimensional model 225 may be further configured such that the geometry of the plurality of polygons is evenly distributed across the polymesh. Digital sculpting techniques known in the art may be used to sculpt three-dimensional model 225 into a three-dimensional original work. Such techniques may include nudge, pinch, polish, build up, move, transpose, and any other techniques known in the art. For example, if the ZBrush software package is the selected digital sculpting program, the aforementioned techniques (or “Brushes” as referenced in that particular software package) may include Transpose, Move, DamStandard, ClayBuildUp, TrimDynamic, Nudge, Pinch, MaskPen, and Polish. Keeping in mind that three-dimensional model 225 will ultimately become a mold for the completed decorative sculpture, the three-dimensional attributes of three-dimensional model 225 should be of sufficient height and depth such that the original subject of two-dimensional image 210 is satisfactorily rendered in the finished product.

In certain embodiments of the present invention, three-dimensional model 225 may further comprise a main model and at least one sub-model. In such embodiments, different aspects of the main model may be sculpted in each of the at least one sub-models such that said aspects may be sculpted individually without affecting the other aspects that will make up final three-dimensional model 225. For example, if three-dimensional model 225 is an intaglio featuring a portrait of a human face, one or more sub-models may be created, with each containing a unique attribute of said face, such as one sub-model for the left eye, one sub-model for the right eye, one-sub-model for the nose, one sub-model for the lips, and so on. The main model may be first configured to represent the base structure from which the three-dimensional portrait will protrude. For example, if the finished product will be a circular intaglio, having a three-dimensional portrait of a human face protruding from its surface, the main model may be configured as a cylindrical polymesh. In other embodiments, such main model may be created by beginning with a spherical polymesh, which is then modified by removing mirroring pieces of said spherical polymesh about one of its three axes, such that a cylinder remains. The shape of the finished product intaglios need not be limited to cylindrical/circular objects, but may include squares, rectangles, hexagons, ovals, and any other shape as desired by the user. Once the individual attributes in the one or more sub-models have been sculpted to the satisfaction of the user and/or artist, they can be merged or otherwise added to the main model which, upon completion, will become finished three-dimensional model 225.

Step 230 may include using three-dimensional printer 235 to print prototype 240 from three-dimensional model 225. Three-dimensional printer 235 may be any printer known in the art configured to print prototype 240 from three-dimensional model 235. In certain embodiments of the present invention, three-dimensional printer 235 may be a digital light processing printer configured to print prototype 240 from a resin or resin-based ink. Moreover, because three-dimensional model 225 is to be printed as prototype 240, it may be desirable for three-dimensional to be configured as a “watertight”—or “closed”—polymesh to ensure proper printing of prototype 240.

In certain embodiments of the present invention, it may be desirable to smooth the surface of prototype 240. In such embodiments, prototype 240 may first be placed into an alcohol bath, or other such substance, such that excess resin is removed. Next, prototype 240 may be exposed to ultra-violet light such that the resin is cured. Once prototype 240 is cured, any remaining excess resin or supporting material from the printing process may be cut off or otherwise removed. Prototype 240 may then be sanded until the surface thereof is smooth. In certain embodiments, the sandpaper used may be a 600 grit wet sandpaper. Prototype 240 may then be painted with a sandable primer and, after said primer has dried, an acrylic paint such than any remaining print lines or other imperfections in the surface of prototype 240 have been removed or filled in such that the surface of prototype 240 has been configured to exhibit the desired smoothness.

Step 245 may include placing prototype 240 into container 250, pouring a volume 255 of a casting solution into container 250 such that prototype 240 is completely submerged in said volume of casting solution 255, and allowing the volume of casting solution 255 to cure. Container 250 may be any container suitably configured to receive and retain a casting solution, and of a sufficient volume such that prototype 240 may be completely submerged by volume of casting solution 255. In certain embodiments, the inner surface of container 250 may include a non-stick coating, such as Teflon, such that container 250 is configured to allow for the easy removal of the volume of casting solution 255 once curing is complete. The casting solution may be any solution suitable for forming a mold. In certain embodiments, the casting solution may be a two-part silicone solution. The casting solution may be cured by any method suitable for the material selected. For example, in certain embodiments wherein the casting solution is a two-part silicone solution, said casting solution may be cured at room temperature for approximately twenty-four hours. Once the volume of casting solution 255 has cured, it can be removed from container 250, and prototype 240 may be removed from volume 255, forming mold 260. The void remaining in mold 260 from the removal of prototype 240 from volume 255 may form mold cavity 265.

Step 270 may include pouring or otherwise inserting a volume of a molding material into mold cavity 265, allowing said volume of molding material to cure, and removing the volume of molding material from mold cavity 265 such that said volume forms intaglio 275. Prior to the introduction of said molding material to mold cavity 265, it may be desirable to pre-treat mold cavity 265 with a mold release solution configured to allow the selected mold material to be easily removed from mold cavity 265 without damaging either intaglio 275 or mold 260. Molding material may be any such material known in the art, including plaster, clay, wax, metal, stone, porcelain, plastic, acrylic, colored acetate, rubber, glass, polyurethane, or other such materials. Accordingly, depending on the desired finished material for intaglio 275, the molding material may require the preparation and mixing of two or more separate solutions. Similarly, curing of the volume of molding material may require the application of heat in a device such as a kiln, oven, or other such device, as necessitated by the molding material selected.

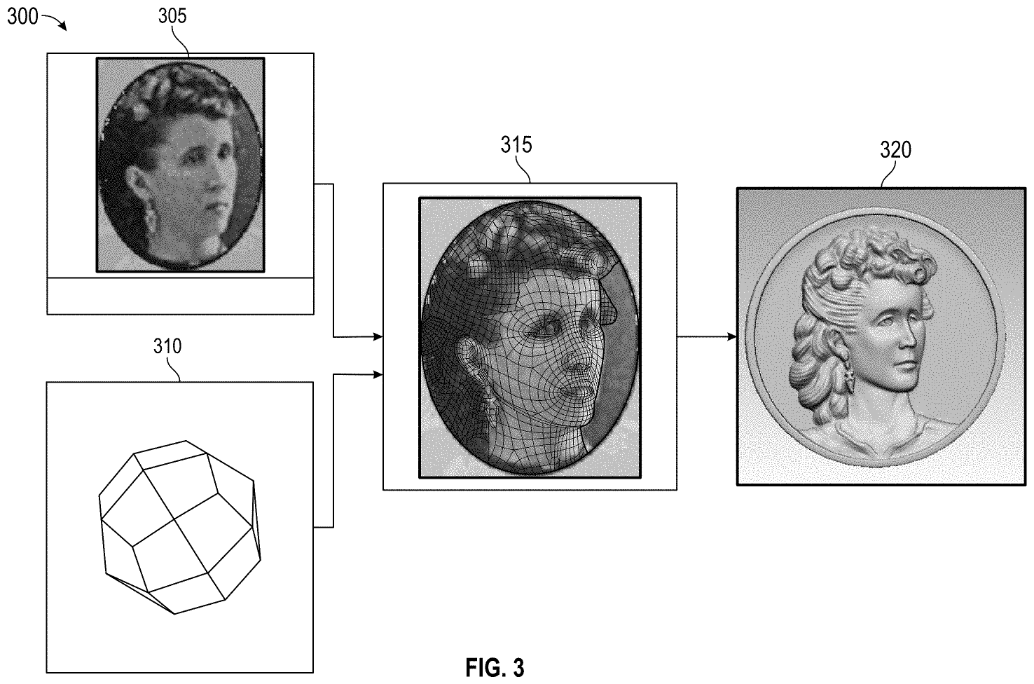

FIG. 3 illustrates certain elements of a method for converting a two-dimensional image into a three-dimensional model according to an exemplary embodiment of the present invention. Once two-dimensional image 305 has been imported into computer having a digital sculpting program, polymesh 310 may be created within said digital sculpting program. Polymesh 310 may be configured to be of a sufficient resolution such that two-dimensional image 305 may be imported onto the surface of polymesh 310. In certain embodiments, said resolution may be at least 128 (i.e., said polymesh is comprised of a plurality of at least 128 polygons). Using the digital sculpting program, two-dimensional image 305 may then be mapped onto polymesh 310 to form three-dimensional model 315. In certain embodiments, two-dimensional image 305 may be mapped on to the surface of polymesh 310 as a texture. Three-dimensional model 315 may then be sculpted using digital sculpting techniques known in the art, such as nudge, pinch, polish, build up, move, transpose, and any other techniques known in the art. The result of said sculpting will be finished three-dimensional model 320 which may be a three-dimensional representation of two-dimensional image 305.

In certain embodiments of the present invention, the two-dimensional subject matter of the three-dimensional sculpture to be created may not be of sufficient size, resolution, or quality for satisfactory mapping to a three-dimensional model. For example, in the case of an antiquated or low-resolution image scanned in to a computer having a digital sculpting program, the low resolution of said image may result in voids or gaps in the image once it is mapped onto the surface of a polymesh created in the digital sculpting program. It may therefore be desirable to import one or more reference images into said digital sculpting program such that the missing components of the three-dimensional model (i.e., the aforementioned voids) may be sculpted independently from the one or more reference images and then merged into the three-dimensional model.

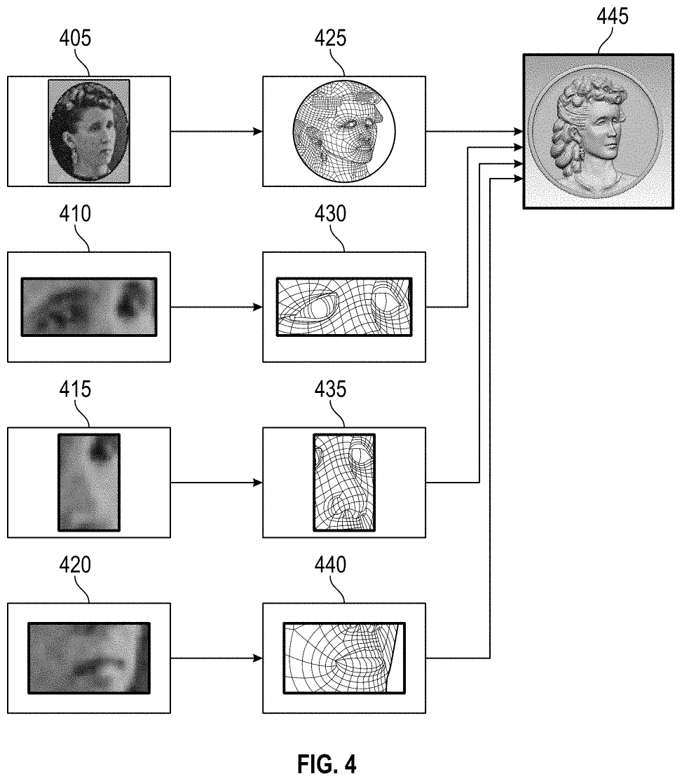

FIG. 4 illustrates certain elements of a method for converting a two-dimensional image into a three-dimensional model according to an exemplary embodiment of the present invention. Two-dimensional subject image 405 may be imported into a computer having a digital sculpting program and mapped onto the surface of main model 425. However, in embodiments of the present invention where subject image 405 is of an insufficient resolution such that voids or gaps are present in main model 425 after image 405 is mapped thereto, it may be desirable to import one or more reference images that may be used to fill in said voids or gaps. In the illustrated embodiment, reference images 410, 415, and 420 may be imported into a computer having a digital sculpting program and mapped onto the surfaces of individual polymeshes to form sub-models 430, 435, and 440, respectively. Each of reference images 410, 415, and 420 and their respective sub-models 430, 435, and 440 may represent a component or attribute of subject image 405 that did not satisfactorily map onto main model 425.

For example, in the embodiment of the present invention illustrated in FIG. 4, subject image 405 may show a portrait of a human face to be converted to a three-dimensional sculpture according to one or more embodiments of the present invention. However, due to insufficient size, quality, or resolution, it may be desirable for a user or artist to locate one or more reference images featuring certain attributes of subject image 405 to be used to fill in the holes or gaps that result from mapping subject image 405 onto main model 425 with a digital sculpting program. Thus, one or more reference images featuring attributes that are substantially similar to certain attributes of subject image 405 may be located and imported into the digital sculpting program. In the illustrated embodiment, reference image 410 features a set of eyes that are substantially similar to the eyes featured in the human face in subject image 405, except that reference image 410 is of a sufficient size, resolution, and quality that it may be satisfactorily mapped onto a polymesh to form sub-model 430. Similarly, reference image 415 may feature a human nose that is substantially similar to the human nose featured in subject image 405, reference image 420 may feature a human mouth that is substantially similar to the human mouth figured in subject image 405, and each of reference images 415 and 420 may be of a sufficient size, resolution, and quality that they it may be satisfactorily mapped on to an individual polymesh to form sub-models 435 and 440, respectively. Each of sub-models 430, 435, and 440 may then be individually sculpted into three-dimensional representations of the respective corresponding attribute of subject image 405. Sub-models 430, 435, and 440 may then be merged into main model 425 to form finished model 445. It should be noted that even if the resolution of the original source image is sufficient for satisfactory mapping to a three-dimensional model, one or more reference images may nevertheless be imported into said digital sculpting program such that independent components of the three-dimensional model may be sculpted independently from each other to achieve the desired finished product. For example, in the event of a portrait, one or more reference images of or containing desired individual facial features may be imported such that said facial features may be sculpted independently and then merged into the desired finished product.

The aforementioned references to the human face featured in subject image 405 are for exemplary purposes only, and the present invention is not limited to the conversion of images of human faces into three-dimensional sculptures. Rather, any subject matter capable of being imaged may be featured in subject image 405, and the one or more reference images may feature certain attributes of said subject image. Similarly, while the embodiments of the present invention are described herein with reference to various implementations and exploitations, it will be understood that these embodiments are illustrative and that the scope of the invention(s) is not limited to them. In general, embodiments of a method for creating a three-dimensional sculpture as described herein may be implemented using methods, facilities, devices, and materials consistent with any appropriate desired sculpture(s). Many variations, modifications, additions, and improvements are possible.

For example, plural instances may be provided for components, operations, or structures described herein as a single instance. Boundaries between various components, operations, and functionality are depicted somewhat arbitrarily, and particular operations are illustrated within the context of specific illustrative configurations. In general, structures and actions presented as separate components or steps in the exemplary configurations may be implemented as a combined structure or step. Similarly, structures and actions presented as a single component or step may be implemented as separate components or steps. These and other variations, modifications, additions, and improvements may fall within the scope of the inventive subject matter. While certain embodiments of the present invention reference the end result as an “intaglio” or a “decorative intaglio,” it will be understood that the present invention is not limited to intaglios, but may also used to create cameos, busts, plaques, silhouettes, reliefs, sculptures, coins, medallions, and any other such three-dimensional works of art.

What is claimed is:

1. A method for creating a sculpture, comprising the steps of:
creating a 3D model with a computer having a 3D sculpting program;
printing a prototype of the 3D model with a 3D printer;
smoothing the surface of the prototype;
placing the prototype into a container;
preparing a casting solution;
pouring a volume of the casting solution into the container such that the prototype is completely submerged in the volume of the casting solution;
allowing the volume of casting solution to cure;
removing the cured volume of casting solution from the container;
removing the prototype from the cured volume of casting solution such that cured volume of casting solution forms a mold having a mold cavity, wherein said mold cavity is formed from the void remaining when the prototype is removed from the cured volume of casting solution;
pouring a volume of a molding material into the mold cavity;
allowing the volume of molding material to cure; and
removing the volume of molding material from the mold cavity such that the volume of molding material forms a sculpture.

2. The method of claim 1, wherein the 3D model is composed of a plurality of polygons configured to form a polymesh having a resolution, and wherein said resolution is equal to the number of polygons in the plurality of polygons.

3. The method of claim 2, wherein the plurality of polygons is evenly distributed across the polymesh.

4. The method of claim 3, wherein the resolution of the polymesh is at least 128.

5. The method of claim 4, wherein the step of creating a 3D model with a computer having a 3D sculpting program further comprises the steps of:
importing a 2D image into the computer having the 3D sculpting program;
creating a 3D model of the 2D image with the 3D sculpting program;
mapping the 2D image onto the surface of the 3D model; and
using the 3D sculpting program to sculpt the 3D model into a three-dimensional representation of the 2D image.

6. The method of claim 5, wherein the 3D model further comprises:
a main model; and
a sub-model,
wherein each of the main model and the sub model are composed of a plurality of polygons; and
wherein the sub-model is configured such that sculpting a portion of the sub-model does not affect the main model.

7. The method of claim 6, wherein the step of creating a 3D model of a 2D image further comprises the steps of:
mapping the 2D image onto the surface of the main model;
importing a two-dimensional reference image into the computer and mapping said two-dimensional reference image onto the surface of the sub-model;
sculpting a portion of the sub-model with the 3D sculpting program such that said sculpted portion of the sub-model corresponds to a three-dimensional representation of a portion of the main model; and
merging the sculpted portion of the sub-model into the main model.

8. The method of claim 5, wherein the 3D model is configured such that a 3D representation of the subject of the 2D image model protrudes from a flat background.

9. The method of claim 5, wherein the 3D model is one of an intaglio, a relief, a plaque, a cameo, a bust, a silhouette, a sculpture, a coin, and a medallion.

10. The method of claim 1, wherein the 3D printer is a digital light processing printer configured to print the prototype from a resin.

11. The method of claim 10, wherein the step of smoothing the surface of the prototype further comprises the steps of:
placing the prototype into an alcohol bath;
exposing the prototype to an ultra-violet light source;
removing extraneous material from the printing process from the prototype;
sanding the prototype with a sandpaper;
applying a primer to the prototype; and
applying an acrylic paint to the prototype.

12. The method of claim 11, wherein the sandpaper is a 600 grit wet sandpaper.

13. The method of claim 1, wherein the container includes an inside surface and is configured for casting.

14. The method of claim 13, wherein the inside surface is treated with a nonstick coating.

15. The method of claim 1, wherein the casting solution is a two-part silicone solution.

16. The method of claim 1, wherein the molding material is one of a plaster, a clay, a wax, a metal, a porcelain, a stone, a plastic, an acrylic, a colored acetate, a rubber, a glass, and a polyurethane.

17. A method for creating a sculpture, comprising the steps of:
importing a 2D image into a computer having a 3D sculpting program;
mapping the 2D image onto the surface of the 3D model;
using the 3D sculpting program to sculpt the 3D model into a three-dimensional representation of the 2D image;
wherein said 3D model is composed of a plurality of polygons configured to form a polymesh having a resolution of at least 128,
wherein said resolution is equal to the number of polygons in the plurality of polygons, and
wherein said plurality of polygons is evenly distributed across the polymesh;
printing a prototype of the 3D model with a 3D printer,
wherein said 3D printer is a digital light processing printer configured to print said prototype from a resin;
placing the prototype into an alcohol bath;
exposing the prototype to an ultra-violet light source;
removing extraneous material from the printing process from the prototype;
sanding the prototype with a sandpaper,
wherein said sandpaper is a 600 grit wet sandpaper;
applying a primer to the prototype;
applying an acrylic paint to the prototype;
placing the prototype into a container having an inside surface and configured for casting,
wherein said inside surface is coated with a non-stick coating;
preparing a casting solution,
wherein said casting solution is a two-part silicone solution;
pouring a volume of the casting solution into the container such that the prototype is completely submerged in the volume of the casting solution;
allowing the volume of casting solution to cure;
removing the cured volume of casting solution from the container;
removing the prototype from the cured volume of casting solution such that cured volume of casting solution forms a mold having a mold cavity, wherein said mold cavity is formed from the void remaining when the prototype is removed from the cured volume of casting solution;
adding a volume of a molding material into the mold cavity;
allowing the volume of molding material to cure; and
removing the volume of molding material from the mold cavity such that the volume of molding material forms a sculpture.

18. The method of claim 17, wherein said 3D model is one of an intaglio, a relief, a cameo, a bust, a silhouette, a plaque, a sculpture, a medallion and a coin.

19. The method of claim 18, wherein the 3D model further comprises:
a main model; and
at least one sub-model,
wherein each of the main model and the at least one sub-model are composed of a plurality of polygons, and
wherein the sub-model is configured such that sculpting a portion of the at least one sub-model does not affect the main model.

20. The method of claim 19, wherein the step of using the 3D sculpting program to sculpt the 3D model into a three-dimensional representation of the 2D image further comprises the steps of:
mapping the 2D image onto the surface of the main model;
selecting at least one 2D reference image;
importing the at least one 2D reference image onto the surface of the at least one sub-model;
sculpting a portion of the at least one sub-model with the 3D sculpting program such that said sculpted portion of the at least one sub-model corresponds to a three-dimensional representation of a portion of the main-model; and
merging the sculpted portion of the at least one sub-model into the main model.
